(19) United States
(12) Patent Application Publication
(10) Pub. No.: US 2004/0188969 A1
(43) Pub. Date: Sep. 30, 2004

(54) Truck corner module with split kingpin support

(76) Inventors: Norbert Huhn, Schweinfurt (DE); Sven Gothberg, Frolunda (CH); Jesko-Henning Tanke, Schweinfurt (DE); Rico Dittmar, Schmalkalden (DE); Hendrikus Jan Kapaan, Nieuwegein (NL)

Correspondence Address: YOUNG & THOMPSON, 745 SOUTH 23RD STREET 2ND FLOOR, ARLINGTON, VA, 22202

(21) Appl. No.: 10/480,484

(22) PCT Filed: Jun. 17, 2002
(86) PCT No.: PCT/NL02/00396

(30) Foreign Application Priority Data
Jun. 15, 2001 (NL) 1018299

(51) Int. Cl. B60G 1/00

(52) U.S. Cl. 280/93.512

(57) ABSTRACT

A truck corner module comprises wheel carrying means with an axle stub (42) and a kingpin arrangement (1,2,8,34) for supporting the axle stub (42) with respect to a truck axle (30), said kingpin arrangement (1,2,8,34) being provided with base member (2) which carries a lower kingpin (3) support and an upper kingpin support (34) which are spaced apart, at least one o the kingpin (3,34) supports being a separate component being intended for assembly with the base member (2) and the kingpin (28) after bringing said kingpin (28) and base member (2) into their normal position with respect to each other.

The invention is related to a truck corner module, comprising Wheel carrying means with an axle stub and a kingpin arrangement for supporting the axle stub with respect to a truck axle, said kingpin arrangement being provided with a base member which carries a lower kingpin support and an upper kingpin support which are spaced apart, at least one of the kingpin supports being a separate component being intended for assembly with the base member and the kingpin after bringing said kingpin and base member into their nominal position with respect to each other.

A truck corner is disclosed in U.S. Pat. No. 1,932,340. Said prior art truck corner has at least one of the kingpin supports as a separate component being intended for assembly with the base member and the kingpin after bringing said kingpin and base member into their nominal position with respect to each other.

According to the invention, the truck corner module is characterized by an auxiliary unit connected to the base member.

The fitting of the upper kingpin support can take place through e.g. screwing onto the lower kingpin support. Thus, the required play is obtained so as to provide the friction values required for optimal steering.

This procedure allows more freedom in assembling the truck corner module. Furthermore, it allows a better access to the components which makes up the truck corner module, which is of importance for e,g, the mounting of the bearing in the kingpin supports.

As mentioned, preferably the lower kingpin support is integrally formed with the base member, and the upper kingpin support is a separate component. Said kingpin supports and the kingpin engage each other through for example axial rolling element bearings. Additionaly, the kingpin supports and the kingpin engage each other through plain thrust bearings. Said plain bearings can be hardened or coated so as to provide optimal wear resistance.

With the aim of simplifying the assembling process, the base member and the upper kingpin support are provided with abutments which define their mutual assembled positions. Preferably, the base member and the upper kingpin support are bolted together.

Furthermore, the kingpin can be provided with a tapered midsection the narrow end of which faces the upper kingpin support said tapered midsection being intended for engagement with a sleeve having a correspondingly tapered base of the vehicle axle. In connection with securing the assembly, the kingpin can be provided with a screw threaded part bordering the narrow end of the midsection, said screw threaded part being intended for engagement with a lock nut which is to bear on the upper end of the sleeve.

A compact, stiff lay-out can be obtained in case the kingpin supports are provided on one face of the base member, and the axle stub is provided on the opposite face of the base member. The axle stub can be integrally formed with the base member. Alternatively, the axle stub can be a separate component, said component and the base member comprising fixation means for fixing the axle stub to the base member. In this respect, the axle stub may comprise a conically or cylindrically shaped end which fits in a correspondingly shaped bore of the base member.

The invention is also related to a method for assembling a truck corner module and a truck axle, comprising the steps of

providing a truck corner module having at least one loose kingpin support,

connecting the truck axle to the kingpin,

assembling said truck corner module by connecting said at least one loose

kingpin support

assembling the a axullar unit.

The wheel carrying means and the kingpin arrangement may consist of cast iron. The module may comprise sensors for measuring rotational speed, load, angular displacement, temperature etc.

The invention will now be described firer with reference to an embodiment of the truck corner module as shown in the figures.

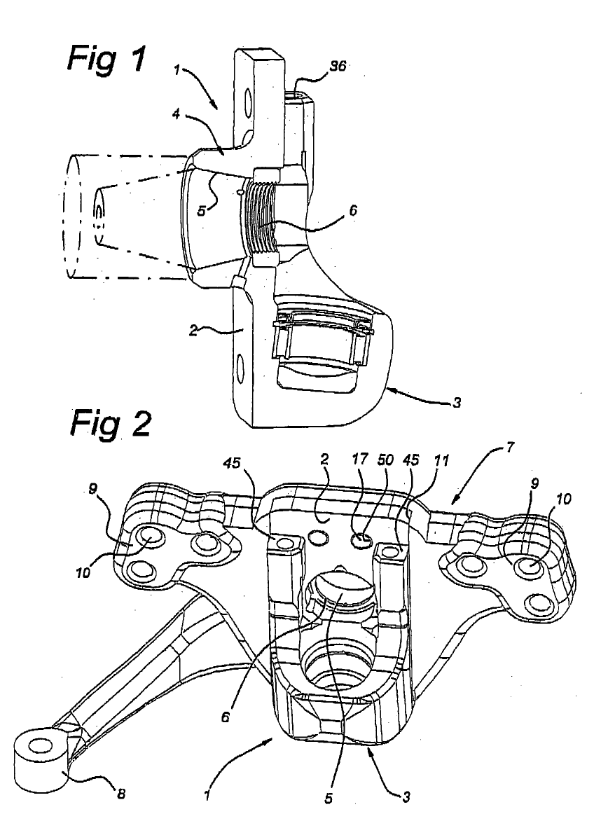

FIG. 1 shows a part of the truck corner module comprising a single kingpin support and a base member.

FIG. 2 shows the part according to FIG. 1 assembled with an=auxiliary unit.

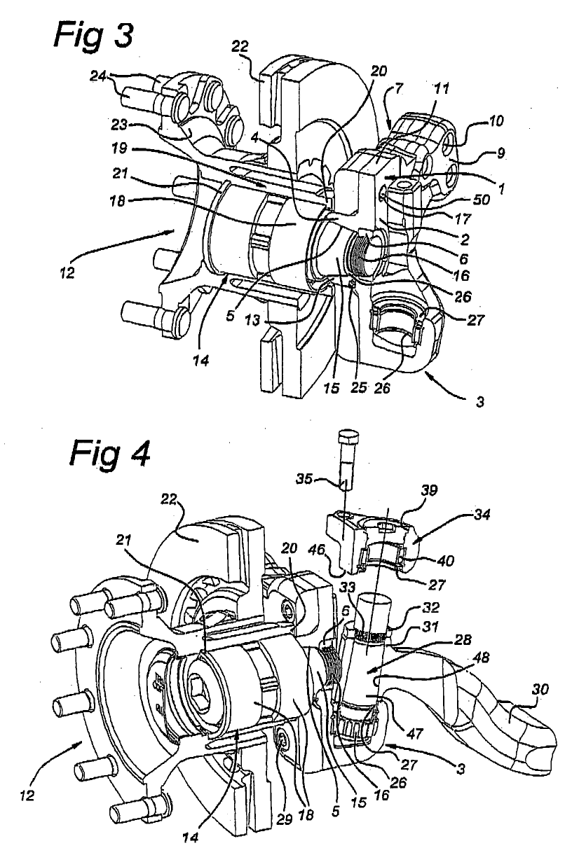

FIG. 3 shows the assembly of FIG. 2, together with a hub unit.

FIG. 4 shows the assembly according to FIG. 3, together with a kingpin and a vehicle axle.

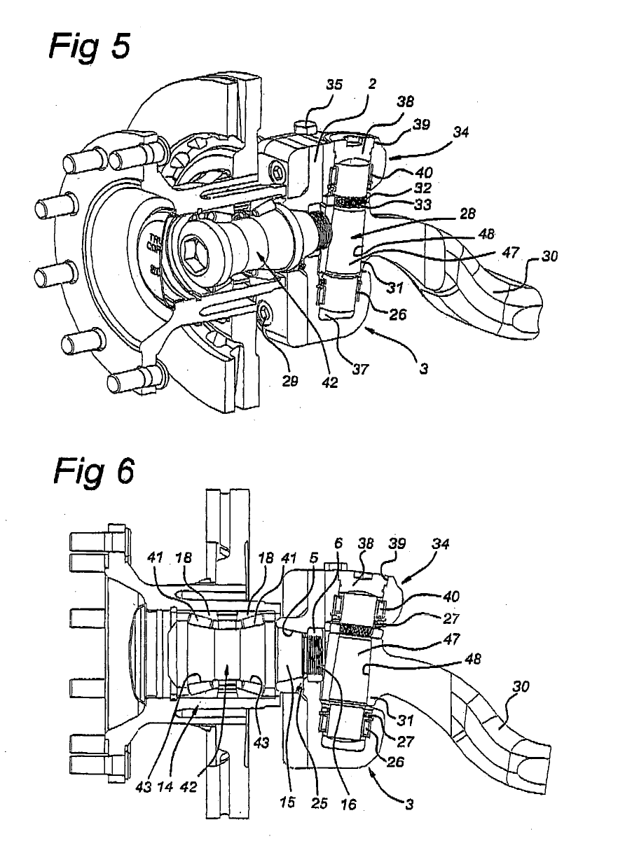

FIG. 5 shows the complete assembled truck corner module, together with vehicle axle.

FIG. 6 shows a cross section to the assembly according to FIG. 5.

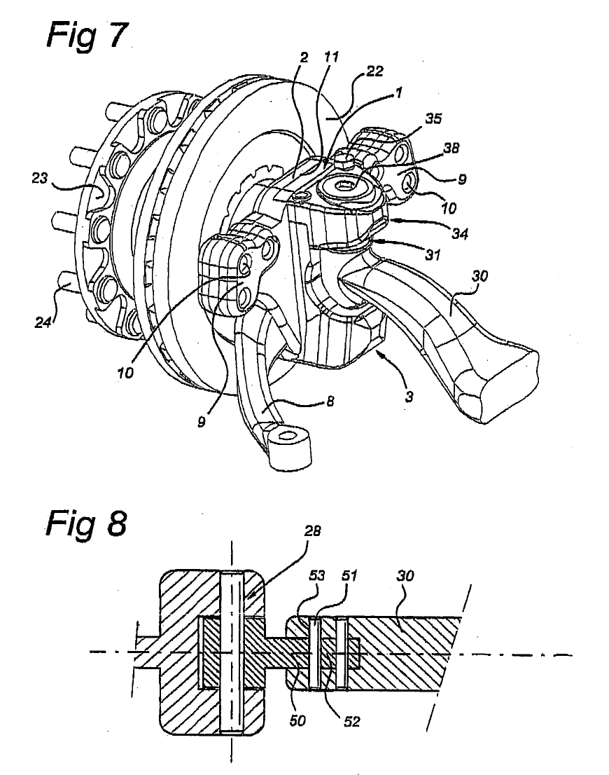

FIG. 7 shows a further view to the assembly according to FIG. 5.

FIG. 8 shows an alternative kingpin layout.

The part 1 shown in FIG. 1 comprises a base member 2, and a lower kingpin support with firms a unity therewith. Further more the part 1 comprises a mounting ring 4 which is intended for connecting a wheel hub bearing unit thereto. This mounting ring 4 comprises a conically shaped inner surface 5 as well as a screw threaded portion 6. This part 1 is assembled with the auxiliary unit shown in FIG. 2, which auxiliary unit i.a. has a steer lever 8 and fixing ears 9 with fixation holes 10 for mounting a disc brake calliper. The part 1 tightly fits within a recess 11 in the auxiliary unit 7.

As shown in FIG. 3, a wheel hub bearing unit 12 is mounted onto this assembly according to FIG. 1. In particular, the inner bearing element 13 of the rolling element bearing 14 of the wheel hub bearing unit is connected through its conical surface 15 and its screw treaded portion 16 in the corresponding conically shaped bore 5 and screw threaded portion 6 of the part 1. By means of bolts 29 inserted in holes 17 running through the part 1 and threaded in the holes 50 of the auxiliary unit 7, the latter components are fixedly connected to each other.

The bearing 14 of the wheel hub bearing unit 12 comprises two outer rings 18, onto which the hub member 19 is mounted through flange 20 and O-ring 21. Said hub member 19 comprises a brake disc 22 as well as a mounting flange 23 with wheel mounting bolts 24.

By means of a lock screw 25 which engages a circumferential groove 26 between the conically shaped part 15 and the screw threaded part 16, the wheel beating unit 12 is locked with respect to the part 1.

Furthermore, the lower kingpin support comprises a roller bearing 26, as well as a seal 27 for sealing the kingpin 28, as shown in FIG. 3 and 4. After the kingpin 28 has been assembled with the bearing 26 in the lower kingpin support 3, the fining 31 of the vehicle axle 13 is lowered onto said kingpin 28. As both the kingpin 28 and the fitting 31 have conically shaped surfaces, a strong reliable force transfer is ensured. Subsequently, a locking nut 32 is treaded upon the screw threaded part 33 of the kingpin 28 so as to lock the kingpin 28 with respect to the fitting 31.

In the next step, the upper kingpin support 34 is placed onto the kingpin 28, and locked with respect to the base member 2 by means of bolts 35 which are threaded into the screw threaded holes 36 (see FIG. 1).

Plain bearings 37, 38 are placed on the lower end and the top end of the kingpin 28. The upper plain bearing 38 can be adjusted by means of its screw threaded connection 39 to the upper kingpin support 34. Furthermore, a rolling bearing 40 and seal 27 is provided in the upper kingpin support 32 which engages the upper end of the kingpin 28.

FIG. 6 shows a cross sectional view, with some details concerning the bearing 14 which comprises two separate outer rings 18, conical rollers 41 and an axle stub 42 having correspondingly shaped raceways 43 therein. The axle stub also caries the conical and threaded connection parts 15, 16.

In FIG. 7 the complete assembly of the truck corner module together with a vehicle axle 30 is depicted.

The embodiment of FIG. 8 comprises a kingpin 28 which has an integral connecting arm 50, which is connected to the vehicle axle 30 through bolts 51 extending through the holes 52, 53 of said components.

1-17. (canceled)

18. Truck corner module, comprising wheel carrying means with an axle stub (42) and a kingpin arrangement (1, 28, 34) for supporting the axle stub (42) with respect to a truck axle (30), said kingpin arrangement (1, 28, 34) being provided with a base member (2) which carries a lower kingpin support (3) and an upper kingpin support (34) which are spaced apart, at least one of the kingpin supports (3, 34) being a separate component being intended for assembly with the base member (2) and the kingpin (28) after bringing said kingpin (28) and base member (2) into their nominal position with respect to each other, characterized by an auxiliary unit (7) connected to the base member (2), said auxiliary unit (7) comprising a steer lever (8) and/or fixing means (9) for fixing a brake calliper thereto, as well as a recess (11) within which the base member (2) together with the lower kingpin support (3) is tightly fitted.

19. Truck corner module, according to claim 18, wherein the lower kingpin support (3) is integrally formed with the base member (2), and the upper kingpin support (34) is a separate component.

20. Truck corner module according to claim 19, wherein the kingpin supports (3, 34) and the kingpin (28) engage each other through (self aligning) rolling element bearings (26,. 40).

21. Truck corner module according to claim 19, wherein the kingpin supports (3, 34) and the kingpin (28) engage each other through plain thrust bearings (37, 38).

22. Truck corner module according to claim 19, wherein the base member (2) and the upper kingpin support (34) are provided with abutments (45, 46) which define their mutual assembled positions.

23. Truck corner module according to claim 19, wherein the base member (2) and the upper kingpin support (34) are bolted (35) together.

24. Truck corner module according to claim 18, wherein the kingpin (28) is provided with a tapered midsection (47) the narrow end of which faces the upper kingpin support (34), said tapered midsection (47) being intended for engagement with a fitting (31) having a correspondingly tapered bore (48) of the vehicle axle (30).

25. Truck corner module according to claim 24, wherein the kingpin (28) is provided with a screw threaded part (33) bordering the narrow end of the midsection (47), said screw threaded part (33) being intended for engagement with a lock nut (32) which is to bear on the upper end of the sleeve (31).

26. Truck corner module according to claim 18, wherein the kingpin supports (3, 34) are provided on one face of the base member (2), and the axle stub (42) is provided on the opposite face of the base member (2).

27. Truck corner module according to claim 26, wherein the axle stub is integrally formed with the base member.

28. Truck corner module according to claim 26, wherein the axle stub (42) is a separate component, said component (42) and the base member (2) comprising fixation/locking means (15, 16; 5, 6) for fixing the axle stub (42) to the base member (2).

29. Truck corner module according to claim 28, wherein the axle stub (42) comprises a conically (15) or cylindrically shaped end which fits in a correspondingly shaped base (5) of the base member (2).

30. Truck corner module according to claim 18, wherein the base member (2) is connected to an auxiliary unit (7) through bolts (29).

31. Truck corner module according to claim 18 wherein the kingpin (28) comprises an integral connection arm (50) for connection to the vehicle axle (30).

32. Method for assembling a truck corner module according to claim 18, and a truck axle, comprising the steps of
providing a truck corner module having at least one loose kingpin support (34)
connecting the truck axle (30) to the kingpin (28)
assembling said truck corner module by connecting said at least one loose kingpin support (34)
assembling the auxiliary unit (7).
